(19) United States
(12) Patent Application Publication
(10) Pub. No.: US 2024/0237060 A1
(43) Pub. Date: Jul. 11, 2024

(54) METHODS, APPARATUSES, AND COMPUTER READABLE MEDIA FOR DATA TRANSMISSION PROCEDURE DETERMINATION

(71) Applicant: Nokia Technologies Oy, Espoo (FI)

(72) Inventors: Samuli Heikki TURTINEN, Oulu (FI); Jussi-Pekka KOSKINEN, Oulu (FI); Chunli WU, Beijing (CN); Sami-Jukka HAKOLA, Oulu (FI)

(21) Appl. No.: 18/559,704

(22) PCT Filed: May 14, 2021
(86) PCT No.: PCT/CN2021/093876

§ 371 Date: Nov. 8, 2023

(51) Int. Cl. H04W 74/08

(52) U.S. Cl. CPC H04W 74/08

(57) ABSTRACT

Disclosed are methods for paging. An example method may include evaluating a transmission power related to uplink data transmission, and determining whether to initiate a small data transmission procedure for the uplink data transmission based on at least one criterion related to a transmission power to be used for the uplink data transmission and the evaluated transmission power. Related apparatuses and computer readable media are also disclosed.

### TECHNICAL FIELD

Various embodiments relate to methods, apparatuses, and computer readable media for data transmission procedure determination.

### BACKGROUND

A small data transmission (SDT) procedure may be initiated by a user equipment (UE) in a radio resource control (RRC) inactive state. To initiate the SDT procedure, the UE does not need to enter into a RRC connected state. For the UE with high gain antennas operating with e.g. millimeter wave (mmWave) and/or in a high frequency range (FR), such as FR2 and above, concerns for health of the user have raised. It has been commonly accepted to use power density (PD) to set restrictions on exposure at the mmWave frequencies, and a maximum permissible exposure (MPE) has been introduced to regulate on the PD for the mmWave regime. However, STD determination mechanisms have not taken into account needs for the UE to comply with MPE requirements.

### SUMMARY

A brief summary of exemplary embodiments is provided below to provide basic understanding of some aspects of various embodiments. It should be noted that this summary is not intended to identify key features of essential elements or define scopes of the embodiments, and its sole purpose is to introduce some concepts in a simplified form as a preamble for a more detailed description provided below.

In a first aspect, disclosed is a method. The method may include evaluating a transmission power related to uplink data transmission, and determining whether to initiate a small data transmission procedure for the uplink data transmission based on at least one criterion related to a transmission power to be used for the uplink data transmission and the evaluated transmission power.

In some embodiments, the evaluating a transmission power may include measuring a power backoff, the at least one criterion may include a first threshold related to the power backoff, and it may be determined to initiate the small data transmission procedure in a case where the measured power backoff is less than or equal to the first threshold.

In some embodiments, the first threshold may be adjusted based on an amount of data to be transmitted in the small data transmission procedure.

In some embodiments, the first threshold may be zero.

In some embodiments, the evaluating a transmission power may include determining whether a single-shot small data transmission is configured, the at least one criterion may include the single-shot small data transmission is configured, and it may be determined to initiate the small data transmission procedure in a case where the single-shot small data transmission is configured.

In some embodiments, the evaluating a transmission power may include determining an amount of data to be transmitted, the at least one criterion may include a second threshold related to a data amount, and it may be determined to initiate the small data transmission procedure in a case where the amount of data to be transmitted is less than the second threshold.

In some embodiments, the evaluating a transmission power may include measuring a power backoff and estimating a power headroom taking into account the measured power backoff, the at least one criterion may include a third threshold related to the power headroom, and it may be determined to initiate the small data transmission procedure in a case where the estimated power headroom is more than the third threshold.

In some embodiments, the evaluating a transmission power may include measuring a power backoff and measuring a reference signal received power, the at least one criterion may include a correspondence between the power backoff and the reference signal received power, and it may be determined to initiate the small data transmission procedure in a case where the measured power backoff and the measured reference signal received power meet the correspondence.

In some embodiments, the method may further include receiving a configuration of the at least one criterion.

In some embodiments, the small data transmission procedure may be a configured grant small data transmission procedure or a random access small data transmission procedure.

In a second aspect, disclosed is a method. The method may include configuring at least one criterion related to a transmission power to be used for an uplink data transmission from a user equipment, and the at least one criterion may be used for the user equipment to determine whether to initiate a small data transmission procedure for the uplink data transmission.

In some embodiments, the at least one criterion may include a first threshold related to a power backoff, and it may be determined to initiate the small data transmission procedure in a case where the power backoff measured by the user equipment is less than the first threshold.

In some embodiments, the first threshold may be adjusted based on an amount of data to be transmitted from the user equipment, in the small data transmission procedure.

In some embodiments, the first threshold may be zero.

In some embodiments, the method may further include configuring a single-shot small data transmission for the user equipment, and it may be determined to initiate the small data transmission procedure in a case where the single-shot small data transmission is configured for the user equipment.

In some embodiments, the at least one criterion may include a second threshold related to a data amount, and it may be determined to initiate the small data transmission procedure in a case where an amount of data to be transmitted by the user equipment is less than the second threshold.

In some embodiments, the at least one criterion may include a third threshold related to a power headroom, the power headroom may be estimated by the user equipment taking into account a power backoff measured by the user equipment, and it may be determined to initiate the small data transmission procedure in a case where the power headroom estimated by the user equipment is more than the third threshold.

In some embodiments, the at least one criterion may include a correspondence between a power backoff and a reference signal received power, and it may be determined to initiate the small data transmission procedure in a case where the power backoff measured by the user equipment and the reference signal received power measured by the user equipment meet the correspondence.

In some embodiments, the method may further include transmitting a configuration of the at least one criterion to the user equipment.

In some embodiments, the small data transmission procedure may be a configured grant small data transmission procedure or a random access small data transmission procedure.

In a third aspect, disclosed is an apparatus. The apparatus may include at least one processor and at least one memory. The at least one memory may include computer program code, and the at least one memory and the computer program code may be configured to, with the at least one processor, cause the apparatus to perform evaluating a transmission power related to uplink data transmission, and determining whether to initiate a small data transmission procedure for the uplink data transmission based on at least one criterion related to a transmission power to be used for the uplink data transmission and the evaluated transmission power.

In some embodiments, the evaluating a transmission power may include measuring a power backoff, the at least one criterion comprises a first threshold related to the power backoff, and it may be determined to initiate the small data transmission procedure in a case where the measured power backoff is less than or equal to the first threshold.

In some embodiments, the first threshold may be adjusted based on an amount of data to be transmitted in the small data transmission procedure.

In some embodiments, the first threshold may be zero.

In some embodiments, the evaluating a transmission power may include determining whether a single-shot small data transmission is configured, the at least one criterion may include the single-shot small data transmission is configured, and it may be determined to initiate the small data transmission procedure in a case where the single-shot small data transmission is configured.

In some embodiments, the evaluating a transmission power may include determining an amount of data to be transmitted, the at least one criterion may include a second threshold related to a data amount, and it may be determined to initiate the small data transmission procedure in a case where the amount of data to be transmitted is less than the second threshold.

In some embodiments, the evaluating a transmission power may include measuring a power backoff and estimating a power headroom taking into account the measured power backoff, the at least one criterion may include a third threshold related to the power headroom, and it may be determined to initiate the small data transmission procedure in a case where the estimated power headroom is more than the third threshold.

In some embodiments, the evaluating a transmission power may include measuring a power backoff and measuring a reference signal received power, the at least one criterion may include a correspondence between the power backoff and the reference signal received power, and it may be determined to initiate the small data transmission procedure in a case where the measured power backoff and the measured reference signal received power meet the correspondence.

In some embodiments, the at least one memory and the computer program code may be further configured to, with the at least one processor, cause the apparatus to further perform receiving a configuration of the at least one criterion.

In some embodiments, the small data transmission procedure may be a configured grant small data transmission procedure or a random access small data transmission procedure.

In a fourth aspect, disclosed is an apparatus. The apparatus may include at least one processor and at least one memory. The at least one memory may include computer program code, and the at least one memory and the computer program code may be configured to, with the at least one processor, cause the apparatus to perform configuring at least one criterion related to a transmission power to be used for an uplink data transmission from a user equipment, the at least one criterion being used for the user equipment to determine whether to initiate a small data transmission procedure for the uplink data transmission.

In some embodiments, the at least one criterion may include a first threshold related to a power backoff, and it may be determined to initiate the small data transmission procedure in a case where the power backoff measured by the user equipment is less than the first threshold.

In some embodiments, the first threshold may be adjusted based on an amount of data to be transmitted from the user equipment, in the small data transmission procedure.

In some embodiments, the first threshold may be zero.

In some embodiments, the at least one memory and the computer program code may be further configured to, with the at least one processor, cause the apparatus to further perform configuring a single-shot small data transmission for the user equipment, and it may be determined to initiate the small data transmission procedure in a case where the single-shot small data transmission is configured for the user equipment.

In some embodiments, the at least one criterion may include a second threshold related to a data amount, and it may be determined to initiate the small data transmission procedure in a case where an amount of data to be transmitted by the user equipment is less than the second threshold.

In some embodiments, the at least one criterion may include a third threshold related to a power headroom, the power headroom may be estimated by the user equipment taking into account a power backoff measured by the user equipment, and it may be determined to initiate the small data transmission procedure in a case where the power headroom estimated by the user equipment is more than the third threshold.

In some embodiments, the at least one criterion may include a correspondence between a power backoff and a reference signal received power, and it may be determined to initiate the small data transmission procedure in a case where the power backoff measured by the user equipment and the reference signal received power measured by the user equipment meet the correspondence.

In some embodiments, the at least one memory and the computer program code may be further configured to, with the at least one processor, cause the apparatus to further perform transmitting a configuration of the at least one criterion to the user equipment.

In some embodiments, the small data transmission procedure may be a configured grant small data transmission procedure or a random access small data transmission procedure.

In a fifth aspect, disclosed is an apparatus. The apparatus may include means for evaluating a transmission power related to uplink data transmission, and means for determining whether to initiate a small data transmission procedure for the uplink data transmission based on at least one criterion related to a transmission power to be used for the uplink data transmission and the evaluated transmission power.

In some embodiments, the means for evaluating a transmission power may include means for measuring a power backoff, the at least one criterion may include a first threshold related to the power backoff, and it may be determined to initiate the small data transmission procedure in a case where the measured power backoff is less than or equal to the first threshold.

In some embodiments, the first threshold may be adjusted based on an amount of data to be transmitted in the small data transmission procedure.

In some embodiments, the first threshold may be zero.

In some embodiments, the means for evaluating a transmission power may include means for determining whether a single-shot small data transmission is configured, the at least one criterion may include the single-shot small data transmission is configured, and it may be determined to initiate the small data transmission procedure in a case where the single-shot small data transmission is configured.

In some embodiments, the means for evaluating a transmission power may include means for determining an amount of data to be transmitted, the at least one criterion may include a second threshold related to a data amount, and it may be determined to initiate the small data transmission procedure in a case where the amount of data to be transmitted is less than the second threshold.

In some embodiments, the means for evaluating a transmission power may include means for measuring a power backoff and estimating a power headroom taking into account the measured power backoff, the at least one criterion may include a third threshold related to the power headroom, and it may be determined to initiate the small data transmission procedure in a case where the estimated power headroom is more than the third threshold.

In some embodiments, the means for evaluating a transmission power may include means for measuring a power backoff and measuring a reference signal received power, the at least one criterion may include a correspondence between the power backoff and the reference signal received power, and it may be determined to initiate the small data transmission procedure in a case where the measured power backoff and the measured reference signal received power meet the correspondence.

In some embodiments, the apparatus may further include means for receiving a configuration of the at least one criterion.

In some embodiments, the small data transmission procedure may be a configured grant small data transmission procedure or a random access small data transmission procedure.

In a sixth aspect, disclosed is an apparatus. The apparatus may include means for configuring at least one criterion related to a transmission power to be used for an uplink data transmission from a user equipment, and the at least one criterion may be used for the user equipment to determine whether to initiate a small data transmission procedure for an uplink data transmission.

In some embodiments, the at least one criterion may include a first threshold related to a power backoff, and it may be determined to initiate the small data transmission procedure in a case where the power backoff measured by the user equipment is less than the first threshold.

In some embodiments, the first threshold may be adjusted based on an amount of data to be transmitted from the user equipment, in the small data transmission procedure.

In some embodiments, the first threshold may be zero.

In some embodiments, the apparatus may further include means for configuring a single-shot small data transmission for the user equipment, and it may be determined to initiate the small data transmission procedure in a case where the single-shot small data transmission is configured for the user equipment.

In some embodiments, the at least one criterion may include a second threshold related to a data amount, and it may be determined to initiate the small data transmission procedure in a case where an amount of data to be transmitted by the user equipment is less than the second threshold.

In some embodiments, the at least one criterion may include a third threshold related to a power headroom, the power headroom may be estimated by the user equipment taking into account a power backoff measured by the user equipment, and it may be determined to initiate the small data transmission procedure in a case where the power headroom estimated by the user equipment is more than the third threshold.

In some embodiments, the at least one criterion may include a correspondence between a power backoff and a reference signal received power, and it may be determined to initiate the small data transmission procedure in a case where the power backoff measured by the user equipment and the reference signal received power measured by the user equipment meet the correspondence.

In some embodiments, the apparatus may further include means for transmitting a configuration of the at least one criterion to the user equipment.

In some embodiments, the small data transmission procedure may be a configured grant small data transmission procedure or a random access small data transmission procedure.

In a seventh aspect, a computer readable medium is disclosed. The computer readable medium may include instructions stored thereon for causing an apparatus to perform evaluating a transmission power related to uplink data transmission, and determining whether to initiate a small data transmission procedure for the uplink data transmission based on at least one criterion related to a transmission power to be used for the uplink data transmission and the evaluated transmission power.

In some embodiments, the evaluating a transmission power may include measuring a power backoff, the at least one criterion may include a first threshold related to the power backoff, and it may be determined to initiate the small data transmission procedure in a case where the measured power backoff is less than or equal to the first threshold.

In some embodiments, the first threshold may be adjusted based on an amount of data to be transmitted in the small data transmission procedure.

In some embodiments, the first threshold may be zero.

In some embodiments, the evaluating a transmission power may include determining whether a single-shot small data transmission is configured, the at least one criterion may include the single-shot small data transmission is configured, and it may be determined to initiate the small data transmission procedure in a case where the single-shot small data transmission is configured.

In some embodiments, the evaluating a transmission power may include determining an amount of data to be transmitted, the at least one criterion may include a second threshold related to a data amount, and it may be determined to initiate the small data transmission procedure in a case where the amount of data to be transmitted is less than the second threshold.

In some embodiments, the evaluating a transmission power may include measuring a power backoff and estimating a power headroom taking into account the measured power backoff, the at least one criterion may include a third threshold related to the power headroom, and it may be determined to initiate the small data transmission procedure in a case where the estimated power headroom is more than the third threshold.

In some embodiments, the evaluating a transmission power may include measuring a power backoff and measuring a reference signal received power, the at least one criterion may include a correspondence between the power backoff and the reference signal received power, and it may be determined to initiate the small data transmission procedure in a case where the measured power backoff and the measured reference signal received power meet the correspondence.

In some embodiments, the computer readable medium may further include instructions stored thereon for causing an apparatus to further perform receiving a configuration of the at least one criterion.

In some embodiments, the small data transmission procedure may be a configured grant small data transmission procedure or a random access small data transmission procedure.

In an eighth aspect, a computer readable medium is disclosed. The computer readable medium may include instructions stored thereon for causing an apparatus to perform configuring at least one criterion related to a transmission power to be used for an uplink data transmission from a user equipment, and the at least one criterion may be used for the user equipment to determine whether to initiate a small data transmission procedure for the uplink data transmission.

In some embodiments, the at least one criterion may include a first threshold related to a power backoff, and it may be determined to initiate the small data transmission procedure in a case where the power backoff measured by the user equipment is less than the first threshold.

In some embodiments, the first threshold may be adjusted based on an amount of data to be transmitted from the user equipment, in the small data transmission procedure.

In some embodiments, the first threshold may be zero.

In some embodiments, the method may further include configuring a single-shot small data transmission for the user equipment, and it may be determined to initiate the small data transmission procedure in a case where the single-shot small data transmission is configured for the user equipment.

In some embodiments, the at least one criterion may include a second threshold related to a data amount, and it may be determined to initiate the small data transmission procedure in a case where an amount of data to be transmitted by the user equipment is less than the second threshold.

In some embodiments, the at least one criterion may include a third threshold related to a power headroom, the power headroom may be estimated by the user equipment taking into account a power backoff measured by the user equipment, and it may be determined to initiate the small data transmission procedure in a case where the power headroom estimated by the user equipment is more than the third threshold.

In some embodiments, the at least one criterion may include a correspondence between a power backoff and a reference signal received power, and it may be determined to initiate the small data transmission procedure in a case where the power backoff measured by the user equipment and the reference signal received power measured by the user equipment meet the correspondence.

In some embodiments, the computer readable medium may further include instructions stored thereon for causing an apparatus to further perform transmitting a configuration of the at least one criterion to the user equipment.

In some embodiments, the small data transmission procedure may be a configured grant small data transmission procedure or a random access small data transmission procedure.

Other features and advantages of the example embodiments of the present disclosure will also be apparent from the following description of specific embodiments when read in conjunction with the accompanying drawings, which illustrate, by way of example, the principles of example embodiments of the present disclosure.

### BRIEF DESCRIPTION OF THE DRAWINGS

Some example embodiments will now be described, by way of non-limiting examples, with reference to the accompanying drawings.

FIG. 1 shows an exemplary sequence chart for data transmission procedure determination according to an embodiment of the present disclosure.

FIG. 2 shows a flow chart illustrating an example method for data transmission procedure determination according to an embodiment of the present disclosure.

FIG. 3 shows a flow chart illustrating an example method for data transmission procedure determination according to an embodiment of the present disclosure.

FIG. 4 shows a block diagram illustrating an apparatus for data transmission procedure determination according to an embodiment of the present disclosure.

FIG. 5 shows a block diagram illustrating an apparatus for data transmission procedure determination according to an embodiment of the present disclosure.

FIG. 6 shows a block diagram illustrating an apparatus for data transmission procedure determination according to an embodiment of the present disclosure.

FIG. 7 shows a block diagram illustrating an apparatus for data transmission procedure determination according to an embodiment of the present disclosure.

Throughout the drawings, same or similar reference numbers indicate same or similar elements. A repetitive description on the same elements would be omitted.

### DETAILED DESCRIPTION

Herein below, some example embodiments are described in detail with reference to the accompanying drawings. The following description includes specific details for the purpose of providing a thorough understanding of various concepts. However, it will be apparent to those skilled in the art that these concepts may be practiced without these specific details. In some instances, well known circuits, techniques and components are shown in block diagram form to avoid obscuring the described concepts and features.

A transmission power of the UE may be taken into account when the UE is to determine a SDT procedure or a non-SDT procedure according to the embodiments of the present disclosure.

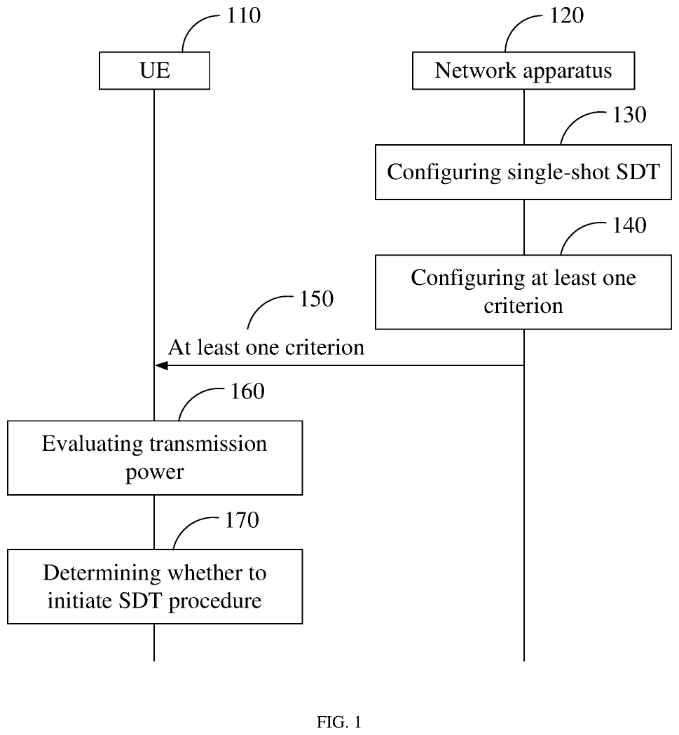

FIG. 1 shows an exemplary sequence chart for data transmission procedure determination according to an embodiment of the present disclosure. Referring to the FIG. 1, a UE 110 may be the UE in the RRC inactive state, and a network apparatus 120 may be an apparatus in a base station (BS) in radio access network (RAN). The UE 110 is located in a cell the network apparatus 120 covers.

In an operation 140, the network apparatus 120 may configure at least one criterion 150 related to a transmission power to be used for an uplink data transmission from the UE 110, and the at least one criterion may be used for the UE 110 to determine whether to initiate the SDT procedure for the uplink data transmission. Then the network apparatus 120 may transmit a configuration of the at least one criterion 150 to the UE 110.

In an embodiment, the at least one criterion 150 may be configured by the network apparatus 120 and the configuration may be transmitted from the network apparatus 120. In this case the UE 110 may receive the configuration of the at least one criterion 150. Additionally or alternatively, in an embodiment, the at least one criterion 150 related to the transmission power to be used for the uplink data transmission from the UE 110 may be preconfigured at the UE 110, and in this case the network apparatus 120 may not configure the at least one criterion 150 and may not transmit the configuration of at least one criterion 150 to the UE 110. Additionally or alternatively, in an embodiment, in a case where the at least one criterion 150 includes a plurality of criteria 150, some of the criteria 150 may be configured by the network apparatus 120 and the configuration of those criteria 150 may be transmitted from the network apparatus 120 to the UE 110 and others of the criteria 150 may be preconfigured at the UE 110.

No matter the at least one criterion 150 is configured by the network apparatus 120 or preconfigured at the UE 110, the UE 110 may follow the at least one criterion 150 to determine whether to initiate the SDT procedure or the non-SDT procedure. The non-SDT procedure may be a regular RRC resume procedure to enter into the RRC connected state.

In an operation 160, the UE 110 may evaluate the transmission power related to uplink data transmission. Depending on which is included in the at least one criterion 150, the UE 110 may make different evaluation to determine the data transmission procedure. The transmission power and the at least one criterion 150 will be described in detail later.

In an operation 170, the UE 110 may determine whether to initiate a SDT procedure for the uplink data transmission based on the at least one criterion 150 related to a transmission power to be used for the uplink data transmission and the evaluated transmission power.

In some embodiments, the at least one criterion 150 may include a first threshold related to a power backoff in an amplifier of the UE 110 for the uplink data transmission. The power backoff in the amplifier is a power level below the first threshold. In this case, in the operation 160, the UE 110 may measure the power backoff of the UE 110 to balance linearity and efficiency of the amplifier. The power backoff may also be a maximum power reduction (MPR), for example a power management MPR (P-MPR), which may represent a power reduction amount decreased from the maximum power of the UE 110.

The first threshold related to the power backoff may be for the UE 110 to determine whether to initiate the SDT procedure. The power backoff measured by the UE 110 may result in a power value calculated by the maximum power deducting the measured power backoff, and lower than or equal to the calculated power value the UE 110 may comply with e.g. the MPE requirements in data transmission. In a case where the measured power backoff is less than or equal to the first threshold, the UE 110 may initiate the SDT procedure while complying with e.g. the MPE requirements. And thus in the operation 170, UE 110 may determine to initiate the SDT procedure in a case where the measured power backoff is less than or equal to the first threshold.

In some embodiments, the first threshold may be adjusted based on an amount of data to be transmitted from the UE 110, in the SDT procedure. For example, in a case where the amount of data to be transmitted in the SDT procedure is smaller, the first threshold may be scaled to a larger value, and in a case where the amount of data to be transmitted in the SDT procedure is larger, the first threshold may be scaled to a small value. So, for the same measured power backoff, the probability for the UE 110 to determine to initiate the SDT procedure in a case where the smaller amount of data is to be transmitted is higher than that in a case where the larger amount of data is to be transmitted.

In some embodiments, the first threshold may be zero. In this case, if in the operation 160 the UE 110 measures the power backoff needed to be applied to meet the MPE requirements, the measured power backoff would be higher than the first threshold, zero here. Thus in the operation 160, the UE 110 may not determine to initiate the SDT procedure, and in this case the UE 110 may determine to initiate the non-SDT procedure.

In some embodiments, the at least one criterion 150 may include a second threshold related to a data amount. In this case, in the operation 160, the UE 110 may determine an amount of data to be transmitted, and in the operation 170, the UE may determine to initiate the SDT procedure in a case where the amount of data to be transmitted is less than the second threshold. It may be appreciated that in some embodiments in the operation 170, the UE may determine to initiate the SDT procedure in a case where the amount of data to be transmitted is less than or equal to the second threshold.

In some embodiments, in a case where the amount of data to be transmitted is less than the second threshold, the UE 110 may determine to initiate the SDT procedure and ignore measuring the power backoff. In this case, the second threshold may be smaller than a data volume allowed for the SDT procedure. For example, assuming that in a case that the data volume allowed for the SDT procedure is 1000 bytes, the second threshold may be for example 200 bytes, that is, the UE 110 may determine to initiate the SDT procedure and ignore measuring the power backoff if the amount of data to be transmitted is less than 200 bytes. And in this case if the amount of data to be transmitted is more than 200 bytes, the UE 110 may for example measure the power backoff and determine whether to initiate the SDT procedure taking into account e.g. the first threshold.

In some embodiments, the at least one criterion 150 may include a third threshold related to a power headroom. The power headroom may represent e.g. a margin for the SDT and for example may be the maximum power deducting a transmission power on which the SDT may be initiated. In order to meet the MPE requirements, the power headroom may be estimated by the UE 110 taking into account the power backoff measured by the UE 110. In this case, in the operation 160, the UE 110 may estimate the power headroom as the maximum power deducting the measured power backoff and deducting the transmission power. And in the operation 170, the UE 110 may determine to initiate the SDT procedure in a case where the power headroom estimated by the UE 110 is more than the third threshold. It may be appreciated that in some embodiments in the operation 170, the UE 110 may determine to initiate the SDT procedure in a case where the power headroom estimated by the UE 110 is more than or equal to the third threshold.

In some embodiments, the at least one criterion 150 may include a correspondence between a power backoff and a reference signal received power, and in this case in the operation 160, the UE 110 may measure a power backoff and measure a reference signal received power (RSRP). In the operation 170, the UE 110 may determine to initiate the SDT procedure in a case where the measured power backoff and the measured RSRP meet the correspondence. A high RSRP may correspond to a high power backoff, and a low RSRP may correspond to a low power backoff. For example, in a case where the UE 110 measures a high RSRP due to e.g. being located close to the center of the cell, the first threshold described above may be set to a relatively high value, and in a case where the UE 110 measures a high power backoff, it is possible for the UE 110 to initiate the SDT procedure if e.g. the power backoff is less than or equal to the first threshold. For example, in a case where the UE 110 measures a low RSRP due to e.g. being located close to the edge of the cell, the first threshold described above may be set to a relatively low value, and in a case where the UE 110 measures a high power backoff, it is possible that the UE 110 may not initiate the SDT procedure if e.g. the power backoff is more than the first threshold but may initiate the non-SDT procedure, and in a case where the UE 110 measures a low power backoff, it is possible for the UE 110 to initiate the SDT procedure if e.g. the power backoff is less than or equal to the first threshold. And thus the correspondence between the power backoff and the RSRP may be that with decreasing of the RSRP, the power backoff allowed for initiating the SDT procedure is decreasing, and with increasing of the RSRP, the power backoff allowed for initiating the SDT procedure is increasing.

In some embodiments, in an operation 130 the network apparatus 120 may configuring a single-shot SDT for the UE 110, and in this case the at least one criterion 150 may include the single-shot SDT is configured. The single-shot SDT may refer to that the uplink data in the SDT is to be transmitted in one data transmission. In comparison, a multi-shot SDT may refer to that the uplink data in the SDT is to be transmitted in multiple data transmissions. The single-shot SDT may be configured for the UE 110 or for the cell. In a case where the single-shot SDT is configured for the UE 110 or for the cell, the multi-shot SDT may also be configured for the UE 110 or for the cell, alternatively, no multi-shot SDT will be configured for the UE 110 or for the cell.

The single-shot SDT may be configured by the network apparatus 120 and that the single-shot SDT is configured may be included in the at least one criterion 150 and be transmitted to the UE 110. Alternatively, the single-shot SDT may be preconfigured for the UE 110 or for the cell, and in this case the network apparatus 120 may not configure the single-shot SDT for the UE 110 or for the cell.

In a case where the at least one criterion 150 may include that the single-shot SDT is configured, in the operation 160 the UE 110 may determine whether the single-shot SDT is configured, and in the operation 170 the UE 110 may determine to initiate the SDT procedure is determined in a case where the single-shot SDT is configured.

Additionally or alternatively the at least one criterion 150 may include that the single-shot SDT is configured for the UE 110 or the cell and no multi-shot SDT is configured for the UE 110 or the cell. In this case in the operation 170 the UE 110 may determine to initiate the SDT procedure is determined in a case where the single-shot SDT is configured and no multi-shot SDT is configured.

In the embodiments described above, the SDT procedure may be a configured grant (CG) SDT procedure or a random access (RA) SDT procedure. The at least one criterion 150 may apply for the UE 110 to determine whether to initiate the SDT procedure. In this case, no matter the CG SDT procedure or the RA SDT procedure, the UE 110 may evaluate the transmission power in the operation 160 and determine to initiate the SDT procedure based on the at least one criterion 150 and the evaluated transmission power in the operation 170.

Alternatively the at least one criterion 150 may apply for the UE 110 to determine whether to the CG SDT procedure. In this case, if the SDT procedure to be initiated is CG SDT, the UE 110 may evaluate the transmission power in the operation 160 and determine to initiate the CG SDT procedure based on the at least one criterion 150 and the evaluated transmission power in the operation 170. And in a case where the SDT procedure to be initiated is RA SDT, the UE 110 may not to perform the operation 160 and the operation 170 and may initiate the RA SDT regardless of the at least one criterion 150 and the transmission power.

According to the embodiments of the present disclosure, the SDT procedure or the CG SDT procedure may not be initiated when it is likely to fail due to the power backoff to comply with the MPE requirements by the UE.

FIG. 2 shows a flow chart illustrating an example method 200 for data transmission procedure determination according to an embodiment of the present disclosure. The example method 200 may be performed for example at a UE such as the UE 110.

Referring to the FIG. 2, the example method 200 may include an operation 210 of evaluating a transmission power related to uplink data transmission, and an operation 220 of determining whether to initiate a small data transmission procedure for the uplink data transmission based on at least one criterion related to a transmission power to be used for the uplink data transmission and the evaluated transmission power.

Details of the operation 210 may refer to the above descriptions with respect to at least the operation 160, and repetitive descriptions thereof are omitted here.

Details of the operation 220 may refer to the above descriptions with respect to at least the operation 170, and repetitive descriptions thereof are omitted here.

In an embodiment, the operation of evaluating a transmission power may include measuring a power backoff, the at least one criterion may include a first threshold related to the power backoff, and it may be determined to initiate the small data transmission procedure in a case where the measured power backoff is less than or equal to the first threshold. The more details may refer to the above descriptions with respect to at least the at least one criterion 150, the operation 160, the operation 170, and the first threshold, and repetitive descriptions thereof are omitted here.

In an embodiment, the first threshold may be adjusted based on an amount of data to be transmitted in the small data transmission procedure. The more details may refer to the above descriptions with respect to at least the first threshold, and repetitive descriptions thereof are omitted here.

In an embodiment, the first threshold may be zero. The more details may refer to the above descriptions with respect to at least the first threshold, and repetitive descriptions thereof are omitted here.

In an embodiment, the operation of evaluating a transmission power may include determining whether a single-shot small data transmission is configured, the at least one criterion may include the single-shot small data transmission is configured, and it may be determined to initiate the small data transmission procedure in a case where the single-shot small data transmission is configured. The more details may refer to the above descriptions with respect to at least the operation 130, the at least one criterion 150, the operation 160, the operation 170, and the single-shot SDT, and repetitive descriptions thereof are omitted here.

In an embodiment, the operation of evaluating a transmission power may include determining an amount of data to be transmitted, the at least one criterion may include a second threshold related to a data amount, and it may be determined to initiate the small data transmission procedure in a case where the amount of data to be transmitted is less than the second threshold. The more details may refer to the above descriptions with respect to at least the at least one criterion 150, the operation 160, the operation 170, and the second threshold, and repetitive descriptions thereof are omitted here.

In an embodiment, the operation of evaluating a transmission power may include measuring a power backoff and estimating a power headroom taking into account the measured power backoff, the at least one criterion may include a third threshold related to the power headroom, and it may be determined to initiate the small data transmission procedure in a case where the estimated power headroom is more than the third threshold. The more details may refer to the above descriptions with respect to at least the at least one criterion 150, the operation 160, the operation 170, and the third threshold, and repetitive descriptions thereof are omitted here.

In an embodiment, the operation of evaluating a transmission power may include measuring a power backoff and measuring a reference signal received power, the at least one criterion may include a correspondence between the power backoff and the reference signal received power, and it may be determined to initiate the small data transmission procedure in a case where the measured power backoff and the measured reference signal received power meet the correspondence. The more details may refer to the above descriptions with respect to at least the at least one criterion 150, the operation 160, the operation 170, and the RSRP, and repetitive descriptions thereof are omitted here.

In an embodiment, the example method 200 may further include an operation of receiving a configuration of the at least one criterion. The more details may refer to the above descriptions with respect to at least the at least one criterion 150, and repetitive descriptions thereof are omitted here.

In an embodiment, the small data transmission procedure may be a configured grant small data transmission procedure or a random access small data transmission procedure. The more details may refer to the above descriptions with respect to at least the CG SDT and the RA SDT, and repetitive descriptions thereof are omitted here.

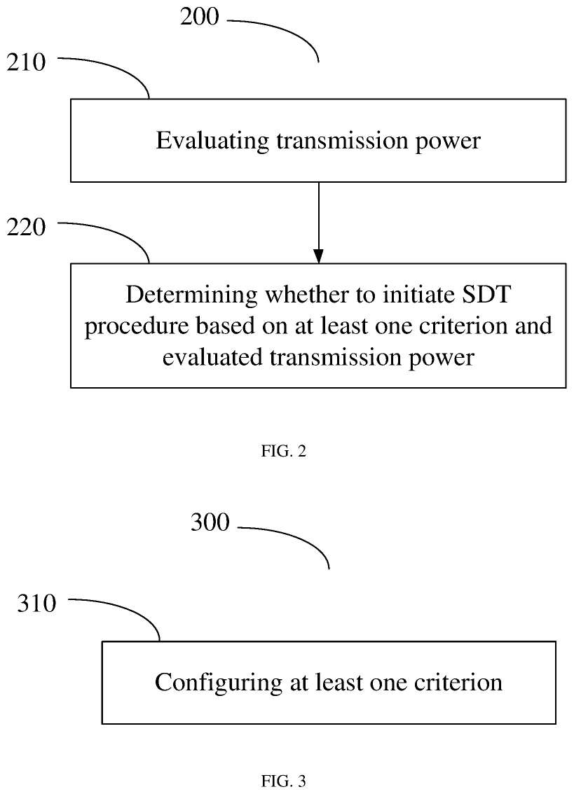

FIG. 3 shows a flow chart illustrating an example method 300 for data transmission procedure determination according to an embodiment of the present disclosure. The example method 300 may be performed for example at a network apparatus in the RAN such as the network apparatus 120.

Referring to the FIG. 3, the example method 300 may include an operation 310 of configuring at least one criterion related to a transmission power to be used for an uplink data transmission from a user equipment, and the at least one criterion is used for a user equipment to determine whether to initiate a small data transmission procedure for the uplink data transmission.

Details of the operation 310 may refer to the above descriptions with respect to at least the operation 140, and the at least one criterion 150, and repetitive descriptions thereof are omitted here.

In an embodiment, the at least one criterion may include a first threshold related to a power backoff, and it may be determined to initiate the small data transmission procedure in a case where the power backoff measured by the user equipment is less than the first threshold. The more details may refer to the above descriptions with respect to at least the at least one criterion 150, the operation 160, the operation 170, and the first threshold, and repetitive descriptions thereof are omitted here.

In an embodiment, the first threshold may be adjusted based on an amount of data to be transmitted from the user equipment, in the small data transmission procedure. The more details may refer to the above descriptions with respect to at least the first threshold, and repetitive descriptions thereof are omitted here.

In an embodiment, the first threshold may be zero. The more details may refer to the above descriptions with respect to at least the first threshold, and repetitive descriptions thereof are omitted here.

In an embodiment, the example method 300 may further include an operation of configuring a single-shot small data transmission for the user equipment, and it may be determined to initiate the small data transmission procedure in a case where the single-shot small data transmission is configured for the user equipment. The more details may refer to the above descriptions with respect to at least the operation 130, the at least one criterion 150, the operation 160, the operation 170, and the single-shot SDT, and repetitive descriptions thereof are omitted here.

In an embodiment, the at least one criterion may include a second threshold related to a data amount, and it may be determined to initiate the small data transmission procedure in a case where an amount of data to be transmitted by the user equipment is less than the second threshold. The more details may refer to the above descriptions with respect to at least the at least one criterion 150, the operation 160, the operation 170, and the second threshold, and repetitive descriptions thereof are omitted here.

In an embodiment, the at least one criterion may include a third threshold related to a power headroom, the power headroom may be estimated by the user equipment taking into account a power backoff measured by the user equipment, and it may be determined to initiate the small data transmission procedure in a case where the power headroom estimated by the user equipment is more than the third threshold. The more details may refer to the above descriptions with respect to at least the at least one criterion 150, the operation 160, the operation 170, and the third threshold, and repetitive descriptions thereof are omitted here.

In an embodiment, the at least one criterion may include a correspondence between a power backoff and a reference signal received power, and it may be determined to initiate the small data transmission procedure in a case where the power backoff measured by the user equipment and the reference signal received power measured by the user equipment meet the correspondence. The more details may refer to the above descriptions with respect to at least the at least one criterion 150, the operation 160, the operation 170, and the RSRP, and repetitive descriptions thereof are omitted here.

In an embodiment, the example method 300 may further include an operation of transmitting a configuration of the at least one criterion to the user equipment. The more details may refer to the above descriptions with respect to at least the operation 140 and the at least one criterion 150, and repetitive descriptions thereof are omitted here.

In an embodiment, the small data transmission procedure may be a configured grant small data transmission procedure or a random access small data transmission procedure. The more details may refer to the above descriptions with respect to at least the CG SDT and the RA SDT, and repetitive descriptions thereof are omitted here.

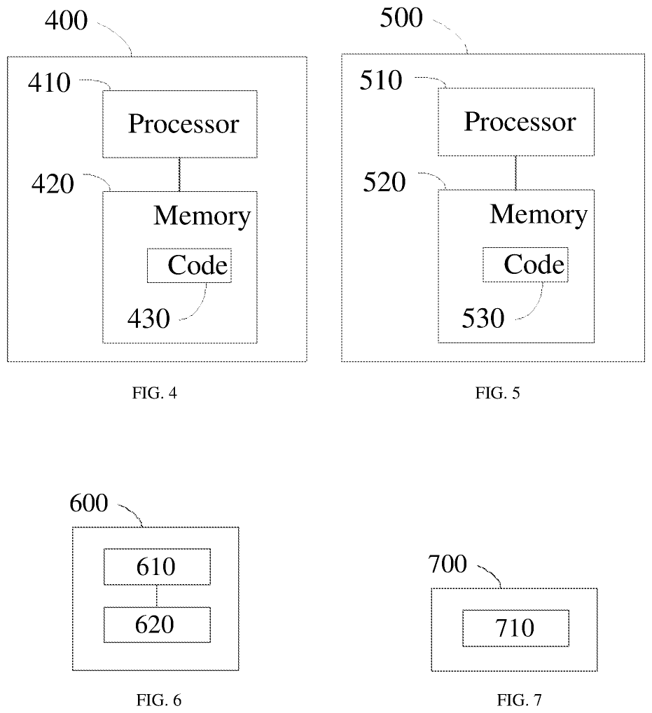

FIG. 4 shows a block diagram illustrating an apparatus for data transmission procedure determination according to an embodiment of the present disclosure. The apparatus, for example, may be at least part of the UE 110 in the above examples.

As shown in the FIG. 4, the example apparatus 400 may include at least one processor 410 and at least one memory 420 that may include computer program code 430. The at least one memory 420 and the computer program code 430 may be configured to, with the at least one processor 410, cause the apparatus 400 at least to perform the example method 200 described above.

In various example embodiments, the at least one processor 410 in the example apparatus 400 may include, but not limited to, at least one hardware processor, including at least one microprocessor such as a central processing unit (CPU), a portion of at least one hardware processor, and any other suitable dedicated processor such as those developed based on for example Field Programmable Gate Array (FPGA) and Application Specific Integrated Circuit (ASIC). Further, the at least one processor 410 may also include at least one other circuitry or element not shown in the FIG. 4.

In various example embodiments, the at least one memory 420 in the example apparatus 400 may include at least one storage medium in various forms, such as a volatile memory and/or a non-volatile memory. The volatile memory may include, but not limited to, for example, a random-access memory (RAM), a cache, and so on. The non-volatile memory may include, but not limited to, for example, a read only memory (ROM), a hard disk, a flash memory, and so on. Further, the at least memory 420 may include, but are not limited to, an electric, a magnetic, an optical, an electromagnetic, an infrared, or a semiconductor system, apparatus, or device or any combination of the above.

Further, in various example embodiments, the example apparatus 400 may also include at least one other circuitry, element, and interface, for example at least one I/O interface, at least one antenna element, and the like.

In various example embodiments, the circuitries, parts, elements, and interfaces in the example apparatus 400, including the at least one processor 410 and the at least one memory 420, may be coupled together via any suitable connections including, but not limited to, buses, crossbars, wiring and/or wireless lines, in any suitable ways, for example electrically, magnetically, optically, electromagnetically, and the like.

It is appreciated that the structure of the apparatus on the side of the UE 110 is not limited to the above example apparatus 400.

FIG. 5 shows a block diagram illustrating an apparatus for data transmission procedure determination according to an embodiment of the present disclosure. The apparatus, for example, may be at least part of the network apparatus 120 in the above examples.

As shown in the FIG. 5, the example apparatus 500 may include at least one processor 510 and at least one memory 520 that may include computer program code 530. The at least one memory 520 and the computer program code 530 may be configured to, with the at least one processor 510, cause the apparatus 500 at least to perform at least one of the example method 300 described above.

In various example embodiments, the at least one processor 510 in the example apparatus 500 may include, but not limited to, at least one hardware processor, including at least one microprocessor such as a central processing unit (CPU), a portion of at least one hardware processor, and any other suitable dedicated processor such as those developed based on for example Field Programmable Gate Array (FPGA) and Application Specific Integrated Circuit (ASIC). Further, the at least one processor 510 may also include at least one other circuitry or element not shown in the FIG. 5.

In various example embodiments, the at least one memory 520 in the example apparatus 500 may include at least one storage medium in various forms, such as a volatile memory and/or a non-volatile memory. The volatile memory may include, but not limited to, for example, a random-access memory (RAM), a cache, and so on. The non-volatile memory may include, but not limited to, for example, a read only memory (ROM), a hard disk, a flash memory, and so on. Further, the at least memory 520 may include, but are not limited to, an electric, a magnetic, an optical, an electromagnetic, an infrared, or a semiconductor system, apparatus, or device or any combination of the above.

Further, in various example embodiments, the example apparatus 500 may also include at least one other circuitry, element, and interface, for example at least one I/O interface, at least one antenna element, and the like.

In various example embodiments, the circuitries, parts, elements, and interfaces in the example apparatus 500, including the at least one processor 510 and the at least one memory 520, may be coupled together via any suitable connections including, but not limited to, buses, crossbars, wiring and/or wireless lines, in any suitable ways, for example electrically, magnetically, optically, electromagnetically, and the like.

It is appreciated that the structure of the apparatus on the side of the network apparatus 120 is not limited to the above example apparatus 500.

FIG. 6 shows a block diagram illustrating an apparatus for data transmission procedure determination according to an embodiment of the present disclosure. The apparatus, for example, may be at least part of the UE 110 in the above examples.

As shown in FIG. 6, the example apparatus 600 may include means 610 for performing the operation 210 of the example method 200, and means 620 for performing the operation 220 of the example method 200. In one or more another example embodiments, at least one I/O interface, at least one antenna element, and the like may also be included in the example apparatus 600.

In some example embodiments, examples of means in the example apparatus 600 may include circuitries. For example, an example of means 610 may include a circuitry configured to perform the operation 210 of the example method 200, and an example of means 620 may include a circuitry configured to perform the operation 220 of the example method 200. In some example embodiments, examples of means may also include software modules and any other suitable function entities.

FIG. 7 shows a block diagram illustrating an apparatus for data transmission procedure determination according to an embodiment of the present disclosure. The apparatus, for example, may be at least part of the network apparatus 120 in the above examples.

As shown in the FIG. 7, the example apparatus 700 may include means 710 for performing the operation 310 of the example method 300. In one or more another example embodiments, at least one I/O interface, at least one antenna element, and the like may also be included in the example apparatus 700.

In some example embodiments, examples of means in the example apparatus 700 may include circuitries. For example, an example of means 710 may include a circuitry configured to perform the operation 310 of the example method 300. In some example embodiments, examples of means may also include software modules and any other suitable function entities.

The term “circuitry” throughout this disclosure may refer to one or more or all of the following: (a) hardware-only circuit implementations (such as implementations in only analog and/or digital circuitry); (b) combinations of hardware circuits and software, such as (as applicable) (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions); and (c) hardware circuit(s) and or processor(s), such as a microprocessor(s) or a portion of a microprocessor(s), that requires software (e.g., firmware) for operation, but the software may not be present when it is not needed for operation. This definition of circuitry applies to one or all uses of this term in this disclosure, including in any claims. As a further example, as used in this disclosure, the term circuitry also covers an implementation of merely a hardware circuit or processor (or multiple processors) or portion of a hardware circuit or processor and its (or their) accompanying software and/or firmware. The term circuitry also covers, for example and if applicable to the claim element, a baseband integrated circuit or processor integrated circuit for a mobile device or a similar integrated circuit in server, a cellular network device, or other computing or network device.

Another example embodiment may relate to computer program codes or instructions which may cause an apparatus to perform at least respective methods described above. Another example embodiment may be related to a computer readable medium having such computer program codes or instructions stored thereon. In some embodiments, such a computer readable medium may include at least one storage medium in various forms such as a volatile memory and/or a non-volatile memory. The volatile memory may include, but not limited to, for example, a RAM, a cache, and so on. The non-volatile memory may include, but not limited to, a ROM, a hard disk, a flash memory, and so on. The non-volatile memory may also include, but are not limited to, an electric, a magnetic, an optical, an electromagnetic, an infrared, or a semiconductor system, apparatus, or device or any combination of the above.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Likewise, the word “connected”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the description using the singular or plural number may also include the plural or singular number respectively. The word “or” in reference to a list of two or more items, that word covers all of the following interpretations of the word: any of the items in the list, all of the items in the list, and any combination of the items in the list.

Moreover, conditional language used herein, such as, among others, “can,” “could,” “might,” “may,” “e.g.,” “for example,” “such as” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

As used herein, the term “determine/determining” (and grammatical variants thereof) can include, not least: calculating, computing, processing, deriving, measuring, investigating, looking up (for example, looking up in a table, a database or another data structure), ascertaining and the like. Also, “determining” can include receiving (for example, receiving information), accessing (for example, accessing data in a memory), obtaining and the like. Also, “determine/determining” can include resolving, selecting, choosing, establishing, and the like.

While some embodiments have been described, these embodiments have been presented by way of example, and are not intended to limit the scope of the disclosure. Indeed, the apparatus, methods, and systems described herein may be embodied in a variety of other forms; furthermore, various omissions, substitutions and changes in the form of the methods and systems described herein may be made without departing from the spirit of the disclosure. For example, while blocks are presented in a given arrangement, alternative embodiments may perform similar functionalities with different components and/or circuit topologies, and some blocks may be deleted, moved, added, subdivided, combined, and/or modified. At least one of these blocks may be implemented in a variety of different ways. The order of these blocks may also be changed. Any suitable combination of the elements and acts of the some embodiments described above can be combined to provide further embodiments. The accompanying claims and their equivalents are intended to cover such forms or modifications as would fall within the scope and spirit of the disclosure.

Abbreviations used in the description and/or in the figures are defined as follows:
BS base station
CG configured grant
FR frequency range
MPE maximum permissible exposure
MPR maximum power reduction
mmWave millimeter wave
PD power density
P-MPR power management MPR
RA random access
RAN radio access network
RRC radio resource control
RSRP reference signal received power
SDT small data transmission
UE user equipment

1.-20. (canceled)

21. An apparatus comprising:
at least one processor; and
at least one memory comprising computer program code, the at least one memory and the computer program code being configured to, with the at least one processor, cause the apparatus to perform:
evaluating a transmission power related to uplink data transmission; and
determining whether to initiate a small data transmission procedure for the uplink data transmission based on at least one criterion related to a transmission power to be used for the uplink data transmission and the evaluated transmission power.

22. The apparatus of claim 21, wherein the evaluating a transmission power comprises measuring a power backoff, the at least one criterion comprises a first threshold related to the power backoff, and it is determined to initiate the small data transmission procedure in a case where the measured power backoff is less than or equal to the first threshold.

23. The apparatus of claim 22, wherein the first threshold is adjusted based on an amount of data to be transmitted in the small data transmission procedure.

24. The apparatus of claim 22, wherein the first threshold is zero.

25. The apparatus of claim 21, wherein the evaluating a transmission power comprises determining whether a single-shot small data transmission is configured, the at least one criterion comprises the single-shot small data transmission is configured, and it is determined to initiate the small data transmission procedure in a case where the single-shot small data transmission is configured.

26. The apparatus of claim 21, wherein the evaluating a transmission power comprises determining an amount of data to be transmitted, the at least one criterion comprises a second threshold related to a data amount, and it is determined to initiate the small data transmission procedure in a case where the amount of data to be transmitted is less than the second threshold.

27. The apparatus of claim 21, wherein the evaluating a transmission power comprises measuring a power backoff and estimating a power headroom taking into account the measured power backoff, the at least one criterion comprises a third threshold related to the power headroom, and it is determined to initiate the small data transmission procedure in a case where the estimated power headroom is more than the third threshold.

28. The apparatus of claim 21, wherein the evaluating a transmission power comprises measuring a power backoff and measuring a reference signal received power, the at least one criterion comprises a correspondence between the power backoff and the reference signal received power, and it is determined to initiate the small data transmission procedure in a case where the measured power backoff and the measured reference signal received power meet the correspondence.

29. The apparatus of claim 21, wherein the at least one memory and the computer program code are further configured to, with the at least one processor, cause the apparatus to further perform:
receiving a configuration of the at least one criterion.

30. The apparatus of claim 21, wherein the small data transmission procedure is a configured grant small data transmission procedure or a random access small data transmission procedure.

31. An apparatus comprising:
at least one processor; and
at least one memory comprising computer program code, the at least one memory and the computer program code being configured to, with the at least one processor, cause the apparatus to perform:
configuring at least one criterion related to a transmission power to be used for an uplink data transmission from a user equipment, the at least one criterion being used for the user equipment to determine whether to initiate a small data transmission procedure for the uplink data transmission.

32. The apparatus of claim 31, wherein the at least one criterion comprises a first threshold related to a power backoff, and it is determined to initiate the small data transmission procedure in a case where the power backoff measured by the user equipment is less than the first threshold.

33. The apparatus of claim 32, wherein the first threshold is adjusted based on an amount of data to be transmitted from the user equipment, in the small data transmission procedure.

34. The apparatus of claim 32, wherein the first threshold is zero.

35. The apparatus of claim 31, wherein the at least one memory and the computer program code are further configured to, with the at least one processor, cause the apparatus to further perform:
configuring a single-shot small data transmission for the user equipment, and
it is determined to initiate the small data transmission procedure in a case where the single-shot small data transmission is configured for the user equipment.

36. The apparatus of claim 31, wherein the at least one criterion comprises a second threshold related to a data amount, and it is determined to initiate the small data transmission procedure in a case where an amount of data to be transmitted by the user equipment is less than the second threshold.

37. The apparatus of claim 31, wherein the at least one criterion comprises a third threshold related to a power headroom, the power headroom is estimated by the user equipment taking into account a power backoff measured by the user equipment, and it is determined to initiate the small data transmission procedure in a case where the power headroom estimated by the user equipment is more than the third threshold.

38. The apparatus of claim 31, wherein the at least one criterion comprises a correspondence between a power backoff and a reference signal received power, and it is determined to initiate the small data transmission procedure in a case where the power backoff measured by the user equipment and the reference signal received power measured by the user equipment meet the correspondence.

39. The apparatus of claim 31, wherein the at least one memory and the computer program code are further configured to, with the at least one processor, cause the apparatus to further perform:
transmitting a configuration of the at least one criterion to the user equipment.

40. The apparatus of claim 31, wherein the small data transmission procedure is a configured grant small data transmission procedure or a random access small data transmission procedure.

41.-44. (canceled)
